(19) United States
(12) Patent Application Publication
(10) Pub. No.: US 2006/0221611 A1
(43) Pub. Date: Oct. 5, 2006

(54) Back light unit and liquid crystal display employing the same

(75) Inventors: Ji-whan Noh, Suwon-si (KR); Ki-bum Seong, Anyang-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/313,690

(22) Filed: Dec. 22, 2005

(30) Foreign Application Priority Data
Apr. 4, 2005 (KR) 10-2005-0028067

(51) Int. Cl. F21V 13/10

(52) U.S. Cl. 362/247; 362/246

(57) ABSTRACT

A direct type backlight unit for improving high uniformity through a reflection barrier wall having a curved surface and a liquid crystal display employing the same are provided. The backlight unit includes: a base plate; a plurality of point light sources arranged in a plurality of lines on the base plate; a diffusion plate which diffuses light emitted from the plural of point light sources and generates a uniform light; and a reflection barrier wall, having a curved reflection surface, which reflects the light emitted from the point light source to the diffusion plate.

### CROSS-REFERENCE TO RELATED PATENT APPLICATION

This application claims priority from Korean Patent Application No. 10-2005-0028067, filed on Apr. 4, 2005, in the Korean Intellectual Property Office, the disclosure of which is incorporated herein in its entirety by reference.

### BACKGROUND OF THE INVENTION

1. Field of the Invention

Methods and apparatuses consistent with the present invention relate to a direct light type backlight unit including a reflection barrier wall having a curved surface for improving a uniformity and to a liquid crystal display employing the same.

2. Description of the Related Art

A liquid crystal display (LCD) is a passive flat panel display that forms an image not using self-luminescence but using incident light from outside the LCD. A backlight unit is disposed behind the LCD to irradiate light toward a liquid crystal panel.

Cold cathode fluorescence lamps (CCFLs) are generally used as light sources of backlight units. However, a CCFL has a short lifetime and degrades color reproducibility. Therefore, recently, light emitting diodes (LEDs) have been used as light sources for backlight units.

FIG. 1 shows an arrangement of LEDs in a conventional backlight unit.

As shown in FIG. 1, light emitting units 110, each including an LED, are arranged as a two-dimensional array on a base plate 100.

FIG. 2 is a schematic cross-sectional view of the conventional backlight unit of FIG. 1.

As shown in FIG. 2, the conventional back light unit includes: the base plate 100; the light emitting units 110 arranged as two-dimensional array on the base plate 100; a reflection and diffusion plate 102 for reflecting and diffusing light emitted from the light emitting units 110 in an upward direction; an optical plate 130 having a plurality of reflection mirrors 120 facing the light emitting units 110; a transparent and diffusion plate 140 for transmitting and diffusing incident light thereon; a brightness enhancement film (BEF) 150 for improving a directionality of light irradiated from the transparent and diffusion plate 130; and a polarizing film 170 for polarizing light from the BEF.

Details of the light emitting unit 110 are shown in FIG. 3. As shown in FIG. 3, the light emitting unit 110 includes: a base 112; a light emitting diode 111 arranged on the base 112; and a side emitter 113 for laterally propagating light emitted from the light emitting diode 111. The light emitting unit 110 of FIG. 3 radiates light in lateral directions and the light directly propagated in an upward direction is intercepted by the reflector mirror 120. Accordingly, the light is indirectly irradiated to a liquid crystal panel (not shown) through the reflector and diffusion plate 140, the BEF 150, and the polarizing film 170 after the light is reflected and diffused in the upward direction by the reflector and diffusion plate 102.

As shown, the conventional backlight unit uses a very complicated structure to uniformly radiate light in an upward direction because the light emitted from the light emitting unit 111 is propagated in lateral directions. Also, since light emitted from one light emitting diode 111 is diffused over a very wide area of the backlight unit, the backlight unit cannot irradiate light onto a specific portion of a liquid crystal panel. Accordingly, the conventional backlight unit cannot be partially turned on or turned off to be synchronized with an image scanning time of the liquid crystal display. Therefore, it is difficult to eliminate a motion blur when pictures change in the liquid crystal display.

### SUMMARY OF THE INVENTION

The present invention provides a direct light type backlight unit having a plurality of divided luminance areas which are sequentially turned on and turned off, and a liquid crystal display employing the same.

The present invention also provides a backlight unit including a reflection barrier wall having a curved surface for improving light uniformity and a liquid crystal display having the same.

According to an exemplary aspect of the present invention, there is provided a backlight unit including: a base plate; a plurality of point light sources arranged in a plurality of lines on the base plate; a diffusion plate which diffuses light emitted from the plurality of point light sources to generate a uniform light; and a reflection barrier wall, having a curved reflection surface, which reflects the light emitted from the point light source to the diffusion plate.

The reflection barrier wall may be formed on the base plate between at least two lines of the point light sources, thereby dividing the backlight unit in a plurality of parallel luminance areas. The curved reflection surface of the reflection barrier wall may be aspheric.

The plurality of point light sources may be mounted on both sides of a point light source mounting member, thereby facing the reflection surface of the reflection barrier wall, and the point light source mounting member may have a stick shape and may project from the base plate. Also, the plurality of point light sources mounted on the point light source mounting member may be upwardly inclined.

The plurality of point light sources of each of the luminance areas may be sequentially turned on based on a predetermined time delay. The plurality of point light sources of each of the luminance areas may be repeatedly turned on and turned off based on a predetermined time period, and the plurality of point light sources of each of the luminance areas may be turned on after a predetermined time delay has elapsed since turning off the plurality of point light sources of a previous luminance area.

The point light source may be one of a laser diode and a light emitting diode.

According to another exemplary aspect of the present invention, there is provided a liquid crystal display having a liquid crystal panel and a backlight unit arranged behind the liquid crystal panel, wherein the backlight unit includes: a base plate; a plurality of point light sources arranged in a plurality of lines on the base plate; a diffusion plate which diffuses light emitted from the plurality of point light sources to generate a uniform light; and a reflection barrier wall, having a curved reflection surface, which reflects the light emitted from the point light source to the diffusion plate.

Each of the luminance areas in the backlight unit may be turned on in synchronization with a scanning time of the liquid crystal panel.

According to another exemplary aspect of the present invention, as method of operating a liquid crystal display is provided. The method comprises: illuminating a liquid crystal panel with a backlight unit. The backlight unit comprises: a base plate, a plurality of point light sources arranged in a plurality of lines on the base plate, a diffusion plate, and a reflection barrier wall, having a curved reflection surface, formed between at least two lines of the plurality of light sources, thereby dividing the plurality of light sources into two or more luminance areas. The method further comprises sequentially turning on the point light sources of the two or more luminance areas based on a predetermined time delay. The method may further comprise sequentially turning off the point light sources of each of the two or more luminance areas based on a second predetermined time delay measured from the time that the point light sources of a previous luminance area are turned off.

### BRIEF DESCRIPTION OF THE DRAWINGS

The above and other exemplary features and advantages of the present invention will become more apparent by the following detailed description of exemplary embodiments thereof with reference to the attached drawings, in which:

FIG. 1 shows an arrangement of LEDs in a conventional backlight unit;

FIG. 2 is a schematic cross-sectional view of the conventional backlight unit of FIG. 1;

FIG. 3 is a magnified view of a light emitting unit 110 shown in FIG. 2;

FIG. 4A is a cross sectional view of a liquid crystal display according to an exemplary embodiment of the present invention;

FIGS. 4B and 4C are perspective views of a backlight unit according to an exemplary embodiment of the present invention;

FIG. 5A shows a driving method of partially turning on LED light sources in a backlight unit according to an exemplary embodiment of the present invention;

FIG. 5B shows a partially turned on LED light sources in a backlight unit according to an exemplary embodiment of the present invention;

FIG. 6 shows paths of light in a backlight unit according to an exemplary embodiment of the present invention;

FIGS. 7A and 7B show a simulation result of a backlight unit according to an exemplary embodiment of the present invention; and

FIGS. 8A and 8B are cross-sectional views of a backlight unit according to another exemplary embodiment of the present invention.

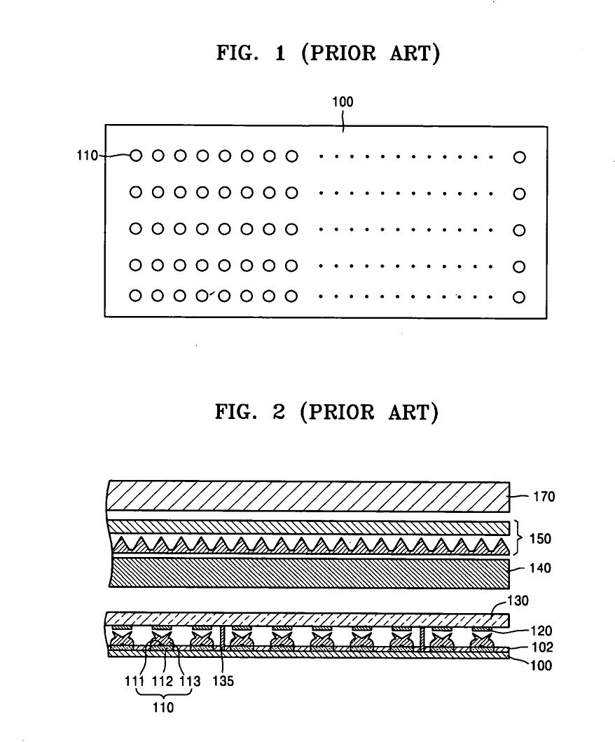

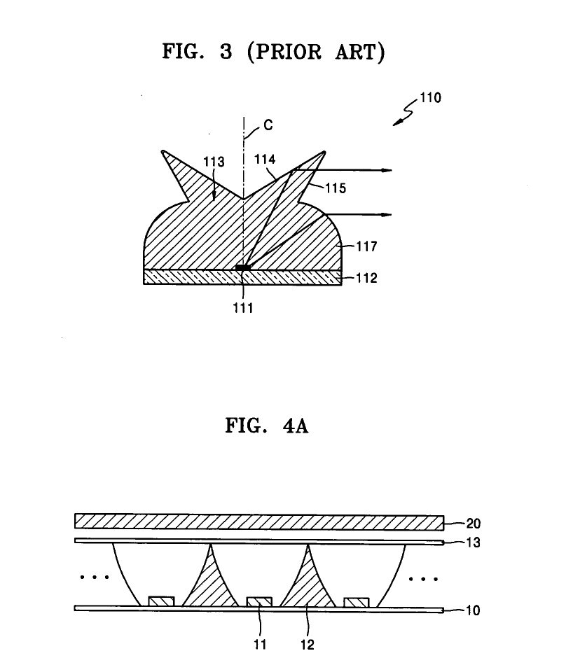

### DETAILED DESCRIPTION OF THE INVENTION

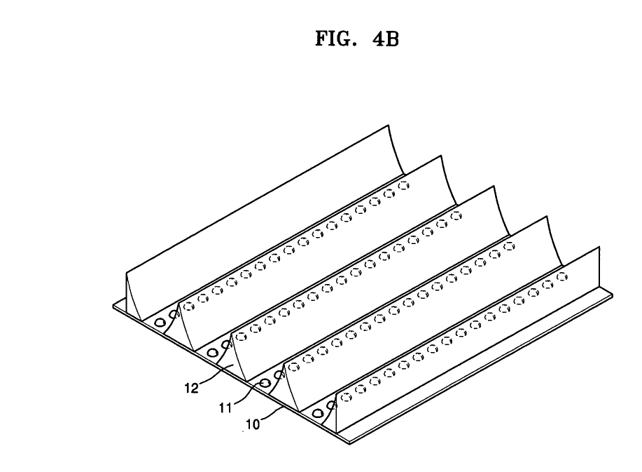

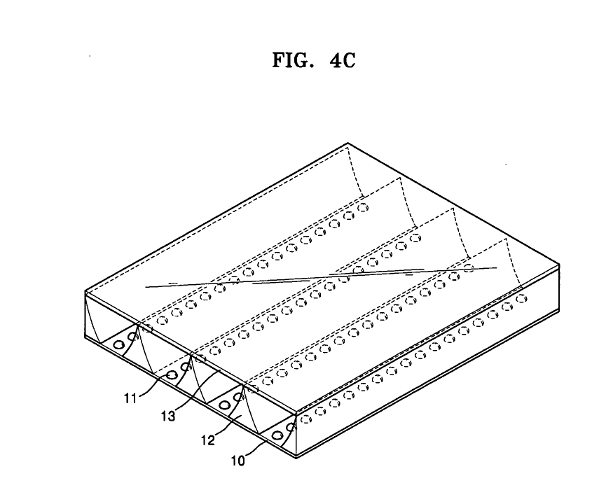

FIG. 4A is a cross sectional view of a liquid crystal display according to an exemplary embodiment of the present invention.

As shown in FIG. 4A, the liquid crystal display according to the present embodiment includes a liquid crystal panel 20 and a backlight unit disposed behind the liquid crystal panel 20. In general, the liquid crystal panel 20 has a bottom glass and a top glass, and liquid crystal is injected between the bottom glass and the top glass. The top glass and the bottom glass are sealed after injecting the liquid crystal. Any type of liquid crystal panel may be used in the present embodiment. The structure of the liquid crystal panel 20 is well known to those skilled in the art, so a detailed explanation thereof is omitted.

The backlight unit according to the present invention includes: a base plate 10; a plurality of point light sources 1 1 arranged on the base plate 10; a diffusion plate 13 which diffuses light emitted from the point light source 11 and generates uniform light; and a reflection barrier wall 12, having a curved surface, which uniformly irradiates the light emitted from the plurality of point light sources 11 to the diffusion plate 13. The structure of the backlight unit will be clearly understood with reference to FIGS. 4B and 4C. FIG. 4B shows the structure of the backlight unit without the diffusion plate and FIG. 4C shows the structure of the backlight unit with the diffusion plate. As shown in FIGS. 4B and 4C, the point light sources 11 are arranged to be in a plurality of lines on the base plate 10. The reflection barrier wall 12, having a reflection curved surface, is formed between the lines of the point light sources 11, and the diffusion plate 13 is arranged above the reflection barrier wall 12.

A laser diode (LD) or a light emitting diode (LED) may be used as the point light source 11. The point light source 11 includes three light sources for emitting red light (R), green light (G), and blue light (B), respectively. As mentioned above, the point light source using the LD or the LED has a longer life time and improved color reproducibility than a point light source using a CCFL.

Since it is possible to turn on or turn off the LD or the LED momentarily, the LD or the LED can be turned on or turned off in synchronization with a scanning time of the liquid crystal display. In order to synchronize the backlight unit with the liquid crystal display, the backlight unit according to the present embodiment is divided into a plurality of luminance areas by arranging a plurality of point light sources 11 in the plurality of lines on the base plate and forming the reflection barrier wall 12 between the lines of the point light sources 1 1, as shown in FIGS. 4A through 4C. The reflection barrier wall 12 prevents diffusion of light emitted from one of point light sources 11 to adjacent luminance areas. At the same time, the reflection barrier wall 12 uniformly diffuses the light within one luminance area by equally reflecting the light to the diffusion plate 13.

In the present embodiment, the number of divided luminance areas, which is the number of the lines of point light sources 11, may be selected according to a size of the liquid crystal panel including the backlight unit. For example, a 26 inch LCD TV includes 768 lines of pixels in a longitudinal direction. If a backlight unit is designed to irradiate 7 lines of pixels with one line of point light sources 11, 110 lines of point light source 15 are required. That is, the backlight unit includes 110 divided luminance areas.

Hereinafter, exemplary operations of a backlight unit according to the present invention will be explained in detail.

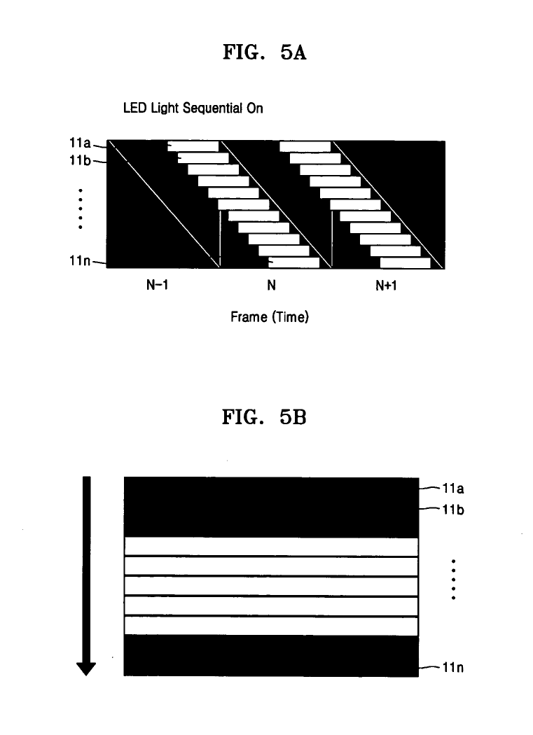

FIG. 5A shows a method of driving a backlight unit according to an exemplary embodiment of the present invention and FIG. 5B shows partially turned on point light sources in a backlight unit according to an exemplary embodiment of the present invention. In FIG. 5A, the horizontal axis represents the frames of a picture, that is, time, and the vertical axis represents a point light source in the backlight unit.

Typically, one frame of a picture is sequentially scanned from an upper portion of the picture to a bottom portion of the picture for forming the image in the LCD TV. An upper portion of the next frame of a picture is scanned before completely scanning a bottom portion of the previous frame. In case of a conventional backlight unit, motion blur is not effectively eliminated since the entire surface of the liquid crystal panel is always irradiated regardless of scanning order. In the present embodiment, the divided luminance areas including a plurality of point light sources are sequentially turned on within a predetermined time interval in synchronization with the scanning time of the liquid crystal panel. Therefore, motion blur is effectively eliminated.

As shown in FIG. 5A, a first luminance area 11a is turned on as soon as an upper portion of the N^{th} frame of a picture is scanned in the liquid crystal panel. After a predetermined interval time has elapsed, point light sources of a second luminance area 11b are turned on according to a scanning time of the liquid crystal panel. A single frame of a picture is scanned completely by sequentially turning on the divided luminance areas until an N^{th} luminance area 11n is turned on according to the above mentioned process. Point light sources of each luminance area are tuned off after a predetermined time has elapsed and they are turned on again to scan the next frame of the picture. That is, the point light sources in each luminance area are repeatedly turned on and off within a predetermined period, and a luminance area is turned on after turning off a previous luminance area and a predetermined interval time has elapsed. The time period for turning on or turning off each luminance area and a delay time for turning on an adjacent luminance area are determined according to a vertical scanning frequency of the liquid crystal panel and the number of luminance areas.

As described above, the divided luminance areas are sequentially turned on within a predetermined period in the backlight unit according to the present embodiment. Therefore, at an arbitrary time, a portion of the backlight unit is turned on according to the present embodiment as shown in FIG. 5B.

Since a portion of the backlight unit partially emits light at a time, the backlight unit according to the present embodiment must prevent light emitted from one of divided luminance areas to be diffused to adjacent divided luminance areas. That is, point light sources of one divided luminance area must not irradiate light to adjacent luminance areas. If the light is irradiated to the adjacent luminance areas, the backlight unit cannot accurately irradiate light to a target area only and a uniformity of light in the target area is degraded. Accordingly, a picture may be overlapped in the liquid crystal panel and spots may be shown on the screen.

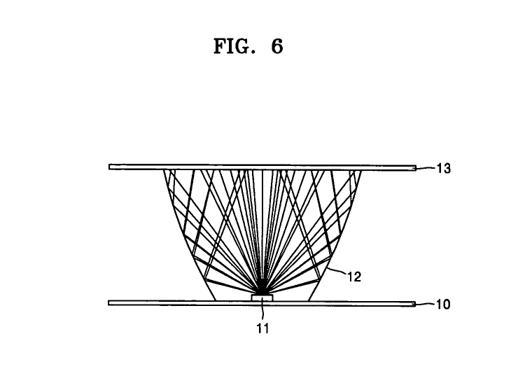

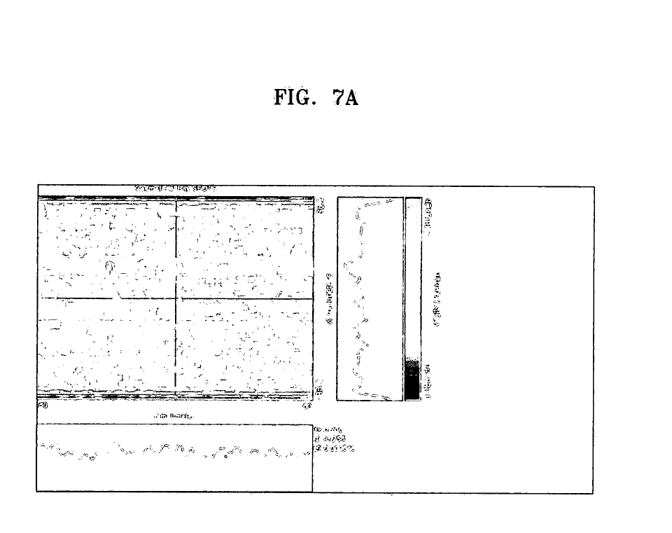

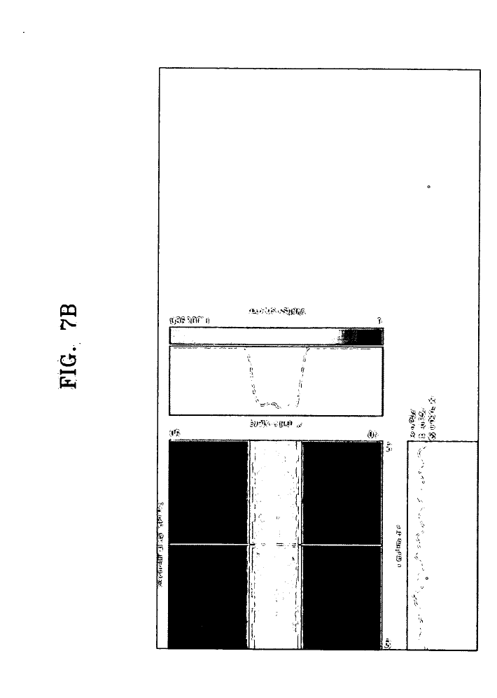

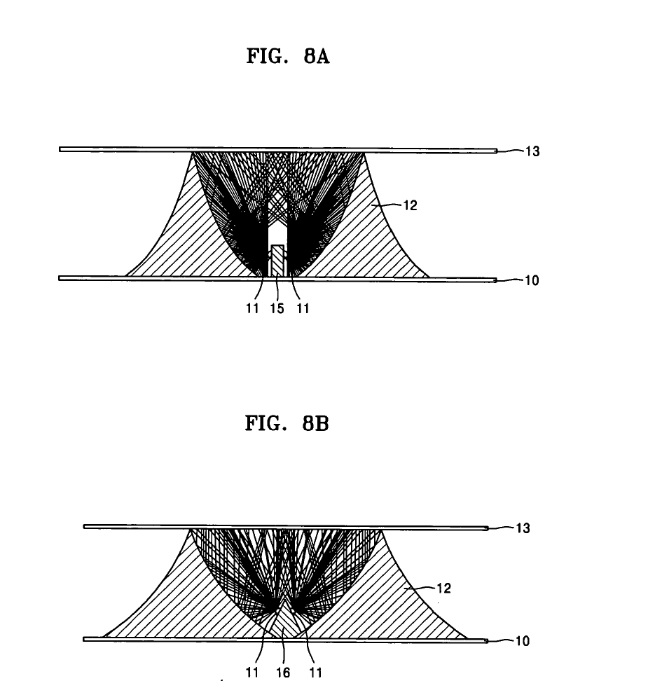

Therefore, the backlight unit according to the present embodiment includes the reflection barrier wall 12 to prevent light to be diffused to unwanted luminance areas. Simultaneously, the reflection barrier wall 12 uniformly reflects the light to the diffusion plate 13 for equally diffusing the light within one luminance area. FIG. 6 shows light emitting paths of the reflection barrier wall 12 in one luminance area of the backlight unit according to the present exemplary embodiment. As shown in FIG. 6, the light emitted from point light sources 11 is reflected by the reflection barrier wall 12 to the diffusion plate 13 without being irradiated the light to adjacent luminance areas.

The point light sources 11 emit a Lambertian light, part of which is wasted in different direction. Therefore, if a flat type reflection surface were used, the central part of a luminance area would be brighter than other parts. That is, a uniformity of the light in the luminance area may be negatively affected. Accordingly, the reflection barrier wall 12 reflects the light emitted from the point light source 11 to uniformly diffuse the light to entire area of a target luminance area. A portion of light emitted from the point light source 11 directly propagates to the diffusion plate 13 and a remaining portion of the light is reflected by a reflection surface of the reflection barrier wall 12 to propagate to the diffusion plate 13. Since the light directly propagated to a central part of the luminance area is comparatively brighter, the reflection surface of the reflection barrier wall 12 may be formed to reflect the light to a peripheral area of the luminance area for preventing the peripheral area from being darker. If the reflection surface is a parabolic surface, the parabolic surface converges the light to the central part or generates a polarized light. Therefore, the reflection surface may be formed as an aspheric surface without a focus.

FIGS. 7A and 7B show the results of simulation using a backlight unit according to an embodiment of the present invention. FIG. 7A shows the result of simulation when the entire region of the backlight unit is turned on, and FIG. 7B shows the result of simulation when the backlight unit is partially turned on. As shown in FIGS. 7A and 7B, superior uniformity can be obtained by using the reflection barrier wall 12 having an aspheric reflection surface.

FIGS. 8A and 8B are cross-sectional views of a backlight unit according to another exemplary embodiment of the present invention. In case of the backlight unit shown in FIG. 4, the point light source 11 is directly mounted on the base plate 10 to directly face the diffusion plate 13. Therefore, the brightest light among the light emitted from the point light source 11 propagates directly to the diffusion plate 13. Accordingly, it is difficult to uniformly irradiate the light to the diffusion plate 13. However, the backlight according to another exemplary embodiment shown in FIGS. 8A and 8B includes a point light source mounting member 15, which has a long stick shape and is formed on the base plate 10 between the reflection barrier walls 12. Point light sources are mounted at both sides of the point light source mounting member 15 so as to face the reflection surfaces of the reflection barrier wall 12. The light emitted from the point light source 11 is irradiated to the diffusion plate 13 through the reflection barrier wall 12. Accordingly, the light uniformity can be further improved. As shown in FIG. 8B, by inclining the both sides of the point light source mounting member 15 to a predetermined angle with respect to the base plate 10, it is possible to mount the point light sources on both sides of the point light source mounting member 15 to face, at a small angle, an upper portion of the reflection barrier wall 12. In this case, light reflected by the reflection barrier wall 12 dose not propagate to the base plate 10. That is, the light is reflected to the diffusion plate 13 without any loss.

As described above, since the backlight unit according to the present invention uses the LD or the LED as a light source instead of the CCFL, the backlight unit according to the present invention has superior color reproducibility and longer light time compared to a conventional backlight unit. Also, since the backlight unit according to the present invention sequentially turns on the light source in synchronization with a scanning time of a liquid crystal display, motion blur is effectively eliminated. Furthermore, the uniformity of light irradiated from the point light source to the diffusion plate is improved because the backlight unit according to the present invention is a direct light type unit and includes the reflection barrier wall having a curved surface. Therefore, image overlapping and spots are not generated.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A backlight unit comprising:
a base plate;
a plurality of point light sources arranged in a plurality of lines on the base plate;
a diffusion plate which diffuses light emitted from the plurality of point light sources to generate a uniform light; and
a reflection barrier wall, having a curved reflection surface, which reflects the light emitted from the point light sources to the diffusion plate.

2. The backlight unit of claim 1, wherein the reflection barrier wall is formed on the base plate between at least two lines of the point light sources, thereby dividing the backlight unit into a plurality of parallel luminance areas.

3. The backlight unit of claim 1, wherein the curved reflection surface of the reflection barrier wall is aspheric.

4. The backlight unit of claim 1, wherein the plurality of point light sources is mounted on both sides of a point light source mounting member, thereby facing the reflection surface of the reflection barrier wall, and wherein the point light source mounting member has a stick shape and projects from the base plate.

5. The backlight unit of claim 4, wherein the plurality of point light sources mounted on the point light source mounting member are upwardly inclined.

6. The backlight unit of claim 2, wherein the plurality of point light sources of each of the luminance areas is sequentially turned on based on a predetermined time delay.

7. The backlight unit of claim 6, wherein the plurality of point light sources of each of the luminance areas is repeatedly turned on and turned off based on a predetermined time period and the plurality of point light sources of each of the luminance areas is turned on after a predetermined time delay has elapsed since turning off the plurality of point light sources of a previous luminance area.

8. The backlight unit of claim 1, wherein each point light source is one of a laser diode and a light emitting diode.

9. A liquid crystal display having a liquid crystal panel and a backlight arranged at the rear of the liquid crystal panel, wherein the backlight unit includes:
a base plate;
a plurality of point light sources arranged in a plurality of lines on the base plate;
a diffusion plate which diffuses light emitted from the plurality of point light sources to generate a uniform light; and
a reflection barrier wall, having a curved reflection surface, which reflects the light emitted from the point light sources to the diffusion plate.

10. The liquid crystal display of claim 9, wherein the reflection barrier wall is formed on the base plate between at least two lines of the point light sources, thereby dividing the backlight unit into a plurality of parallel luminance areas.

11. The liquid crystal display of claim 9, wherein the curved reflection surface of the reflection barrier wall is aspheric.

12. The liquid crystal display of claim 9, wherein the plurality of point light sources is mounted on both sides of a point light source mounting member, thereby facing the reflection surface of the reflection barrier wall, and wherein the point light source mounting member has a stick shape and projects from the base plate.

13. The liquid crystal display of claim 12, wherein the plurality of point light sources mounted on the point light source mounting member are upwardly inclined.

14. The liquid crystal display of claim 10, wherein the plurality of point light sources of each of the luminance areas is sequentially turned on based on a predetermined time delay.

15. The liquid crystal display of claim 14, wherein the plurality of point light sources of each of the luminance areas is repeatedly turned on and turned off based on a predetermined time period and the plurality of point light sources of each of the luminance areas is turned on after a predetermined time delay has elapsed since turning off the plurality of point light sources of a previous luminance area.

16. The liquid crystal display of claim 14, wherein the point light source is one of a laser diode and a light emitting diode.

17. A method of operating a liquid crystal display, comprising: illuminating a liquid crystal panel with a backlight unit comprising:
a base plate, a plurality of point light sources arranged in a plurality of lines on the base plate, a diffusion plate, and a reflection barrier wall, having a curved reflection surface, formed between at least two lines of the plurality of light sources, thereby dividing the plurality of light sources into two or more luminance areas;
sequentially turning on the point light sources of the two or more luminance areas based on a predetermined time delay.

18. The method of claim 17, further comprising:
sequentially turning off the point light sources of each of the two or more luminance areas based on a second predetermined time delay measured from the time that the point light sources of a previous luminance area are turned off.
